(19) United States
(12) Patent Application Publication
(10) Pub. No.: US 2011/0103337 A1
(43) Pub. Date: May 5, 2011

(54) GPS-BASED MULTI-MODE SYNCHRONIZATION AND CLOCKING FEMTO-CELLS, PICO-CELLS AND MACRO BASE STATIONS

(76) Inventors: Roderick Bryant, Conder (AU); Eamonn P. Glennon, New South Wales (AU)

(21) Appl. No.: 12/990,350

(22) PCT Filed: May 1, 2009
(86) PCT No.: PCT/US09/42580

§ 371 Date: Jan. 19, 2011

Related U.S. Application Data
(60) Provisional application No. 61/049,497, filed on May 1, 2008.

(51) Int. Cl. H04W 56/00

(52) U.S. Cl. 370/329

(57) ABSTRACT

A method is disclosed for providing syntonisation, synchronization, position or some combination to a wireless base station, micro-cell, pico-cell, femto-cell or access point, by providing holdover backup in a GPS clock module via at least one interface between the GPS clock module and an external time or frequency reference. Switching between synchronization modes is designed to occur on the control side of the oscillator portion of the module rather than at the output of two oscillators. A corresponding GPS clock module apparatus is disclosed for providing holdover backup via at least one interface between the GPS clock module and external time or frequency references.

### FIELD OF THE INVENTION

This invention relates to the synchronization and clocking of wireless devices such as base stations and access points including but not limited to CDMA and Wideband CDMA (UMTS and CDMA2000) femtocells and picocells and WiMax and LTE access points.

### BACKGROUND OF THE INVENTION

### Base Station Synchronization

GSM is an asynchronous digital cellular telephone technology and hence GSM base stations do not require synchronization unless they are used for positioning of cellular telephone handsets. However, CDMA base stations have always required synchronization to facilitate hand-off of handsets between base stations. Synchronization allows the handset to switch base stations during a call while maintaining track of the spreading code. If the handset is too far out of synch with the spreading code after handoff then it will take too long to reacquire code lock and the call will be lost. In addition, Wideband CDMA (CDMAOne, CDMA2000 and UMTS) base stations and WiMax and LTE broadband access points all require synchronization and syntonisation (frequency control) to relatively stringent requirements.

CDMA base stations have more demanding synchronization requirements and have always employed GPS for synchronization. Typically, the GPS antenna is deployed on a mast external to the building housing the base station and is placed so as to provide an excellent view of the sky.

Conventional base stations use T1 links (or equivalent) for the back-haul and hence employ Synchronous Digital Hierarchy (SDH) globally or Synchronous Optical Networking (SONET) in North America as the transport protocol. This provides a mechanism for syntonisation and synchronization.

FIG. 1 illustrates the major blocks in a typical base station clock. A sophisticated Phase Locked Loop (PLL) circuit phase locks an Oven Controlled Crystal oscillator (OCXO) to the one-pulse-per-second (1 PPS) timing signal from a GPS receiver or to an external 8 kHz reference with the choice being controlled by the Base Station Clock Processor (BSCP). The 1 PPS out is either aligned to the GPS1 PPS or to the external 1 PPS reference depending on whether the PLL is using the GPS or the 8 kHz reference.

The main base station processor communicates with the BSCP via a serial port and the BSCP controls and monitors the status of the GPS receiver via another serial port. In a CDMA or WiMax base station the GPS would be the primary reference but in a UMTS base station the 8 KHz_In and 1PPS_In would be the primary references derived from the SDH back-haul link. In each case, the BSCP would control the switchover to the secondary reference via controls to the PLL circuit. When both GPS and external references are in holdover the BSCP would direct the PLL to hold the control voltage to the OCXO.

In a CDMA base station the timing would be required to holdover to within 8 μs for 24 hours. In order to meet this requirement, a very expensive double-oven OCXO would be incorporated.

Typically, a base station would incorporate 2 complete base station clocks in a redundant configuration in order to allow for hardware failure of the clocks themselves.

### Femto-Cell Synchronization

Such a GPS deployment as is used in CDMA base stations is not economically viable for femto-cells or, to some extent, pico-cells. In these applications, the GPS antennas are embedded in the product either within the plastic enclosure or attached rigidly to the enclosure. Hence, the embedded GPS receiver must operate indoors, generally in an assisted fashion. No redundancy is incorporated.

Various synchronization techniques have been used by UMTS femto-cell developers including:
Synchronizing to the transmissions of adjacent macrocells,
Synchronization over the back-haul network.
GPS

However, femto-cells use the subscriber's broadband internet connection for the back-haul. A tunnel or Virtual Private Network (VPN) connection is established between the femto-cell and the network core. Since the open Internet, with its highly variable latencies, is used for the back-haul, use of the back-haul network for synchronization is extremely problematic. Furthermore, since one of the prime drivers for deploying femto-cells in USA is to overcome the poor indoor cellular coverage typical of US networks, it is not possible to rely on the availability of adjacent macrocell transmissions for synchronization either.

Synchronization via Indoor Assisted GPS is much more accurate than synchronization via the internet and, arguably, is more dependable than synchronization to adjacent cell transmissions. Furthermore, since GPS can provide highly stable frequency as well, it is possible to reduce costs in the femto-cell by causing the GPS receiver to discipline its own oscillator and to supply the clock signal from that oscillator as the master clock or system clock for the femto-cell. This has led to the development of highly integrated low cost GPS Clock Modules (GCMs) for integration within femto-cells to perform the functions described above.

### BRIEF DESCRIPTION OF THE INVENTION

### Holdover Backup

In a small percentage of indoor locations, periods of holdover may be experienced where the GPS signals fade to the point where the synchronization specification may not be maintained. This invention incorporates several schemes that overcome this difficulty by falling back on any of the above alternative synchronization schemes (including SDH/SONET in the case of base station applications) during GPS holdover. It provides a low cost GCM that with enhanced interface capabilities and firmware can be used to do this at minimal additional cost. It also describes how such an enhanced GCM could be used as the core of a very low cost macro base station clock.

### GPS Crock Module

The goal of the invention is to facilitate a scheme to back up GPS synchronization and clocking for femto-cells. The mechanism for doing this must be readily integrated into a low cost GPS Clock Module (GCM) as would be suitable for integration into a femtocell. It must also avoid phase discontinuities in the master clock supplied by the GPS receiver circuit. This implies that any switching between synchronization modes must occur on the control side of the oscillator rather than at the outputs of two oscillators.

FIG. 2 is the block diagram of a GCM within a femto-cell that supplies a master, system or reference clock (SCIk) and a synchronization pulse. Physically, The GCM may be a separate module connected via connectors, a SMT micro-module mounted on one of the femto-cell PCBs or a part of the femto-cell printed board assembly. The key feature of such a GCM is that a single baseband processor is employed and a single low cost oscillator that is disciplined by the baseband firmware and hardware.

In FIG. 2, the synchronization pulse (1 PPS) is output at the rate of 1 pulse per second although, in a given implementation, this could be one pulse per even second instead. The alignment between the 1 PPS and the GPS second or, alternatively, the UTC second is maintained as precisely as possible by a combination of hardware and firmware within the GPS baseband circuit. In addition, the GPS baseband firmware and/or hardware also disciplines the oscillator so that the SCIk is as stable as possible.

In GCM solutions designed for use in femto-cells, the 1PPS alignment is maintained through the oscillator discipline and not by choosing the nearest clock edge as is conventionally done in GPS receivers. The reason for this is to ensure that the number of clock cycles between 1 PPS pulses is always exactly the same. It also has the effect that the clock frequency error is strictly proportional to the change in synchronization error between any two pulses.

### BRIEF DESCRIPTION OF THE DRAWINGS

FIG. 1 depicts a base station clock block.

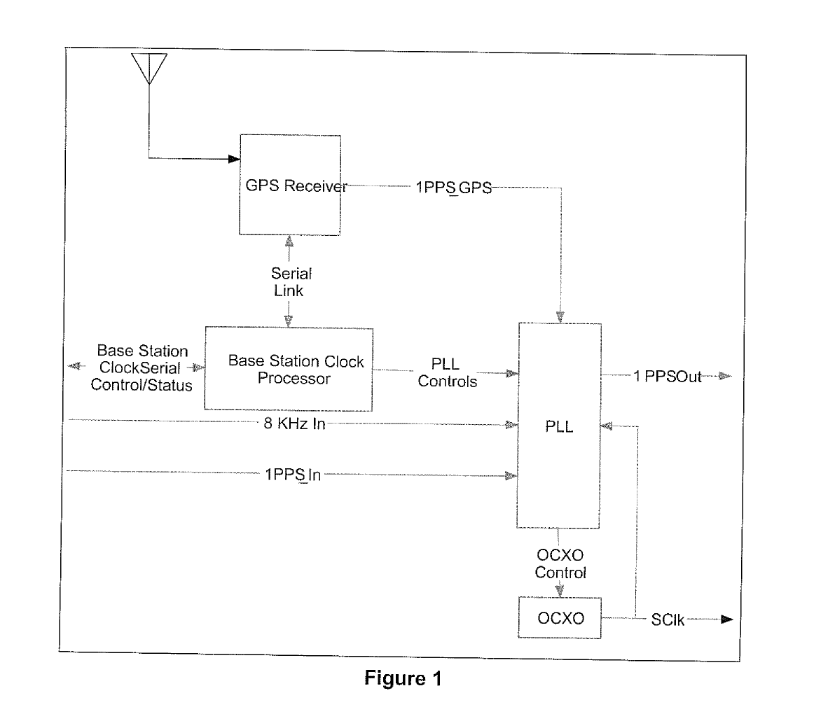

FIG. 2 is a block diagram of a GPS clock module.

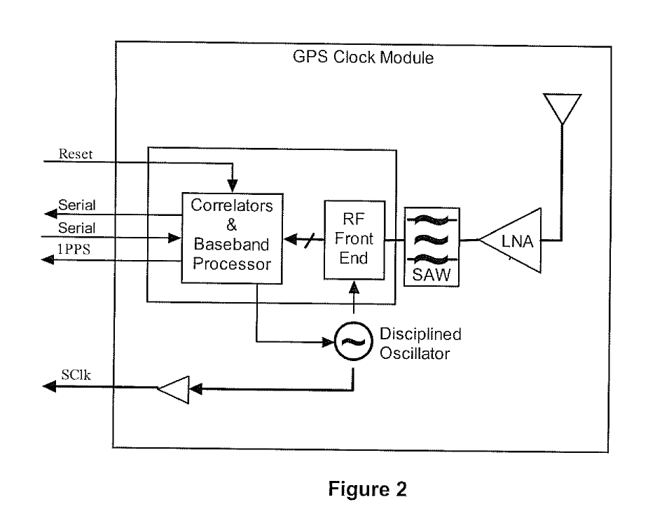

FIG. 3 is a block diagram of GCM with holdover backup.

FIG. 4 is a block diagram of an enhanced GCM.

FIG. 5 is a block diagram of holdover backup scheme 1.

FIG. 6 is a block diagram of holdover backup scheme 2.

FIG. 7 is a block diagram of holdover backup scheme 3.

### DETAILED DESCRIPTION OF PREFERRED EMBODIMENTS OF THE INVENTION

### Hardware Integration Schemes

### H/W Integration Scheme 1

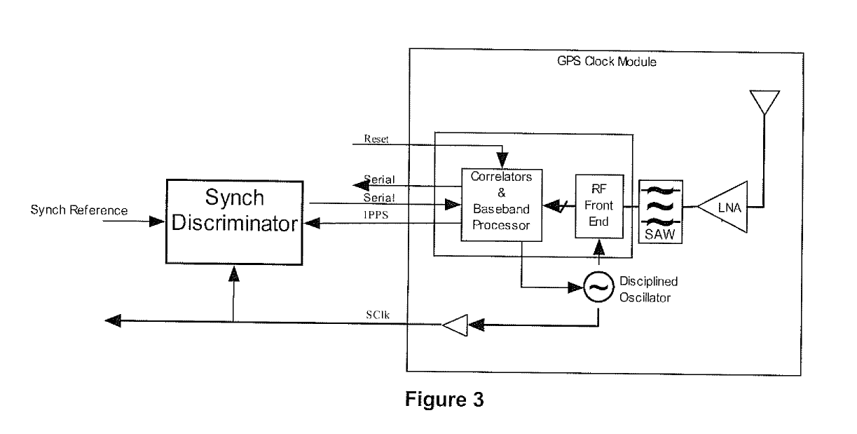

FIG. 3 illustrates a minor modification of the GCM firmware to facilitate a holdover backup facility and the way in which this is integrated into the femto-cell. The femto-cell circuit incorporates a synch discriminator circuit that measures the error in the 1PPS with reference to an independent synchronization reference. It passes this measurement back to the GCM via the serial port.

Note that the 1 PPS is coherent with SCIk and hence SCIk may be used within the synch discriminator to precisely interpolate between the 1 PPS and an external reference event.

The synchronization reference may be derived using any available Non-GPS synchronization scheme and the synch discriminator circuit may be implemented using a combination of hardware and firmware. The synch error passed to the GCM should also include an estimate of the first order error statistics (e.g. standard deviation) in the error measurement. Alternatively these statistics may be known a-priori and stored in the GCM.

Note that the synch discriminator may operate continuously or just during GPS holdover periods. If it operates continuously, the GCM may ignore the error measurements when locked to GPS or may use them in combination with its internal GPS measurements.

### H/W Integration Scheme 2

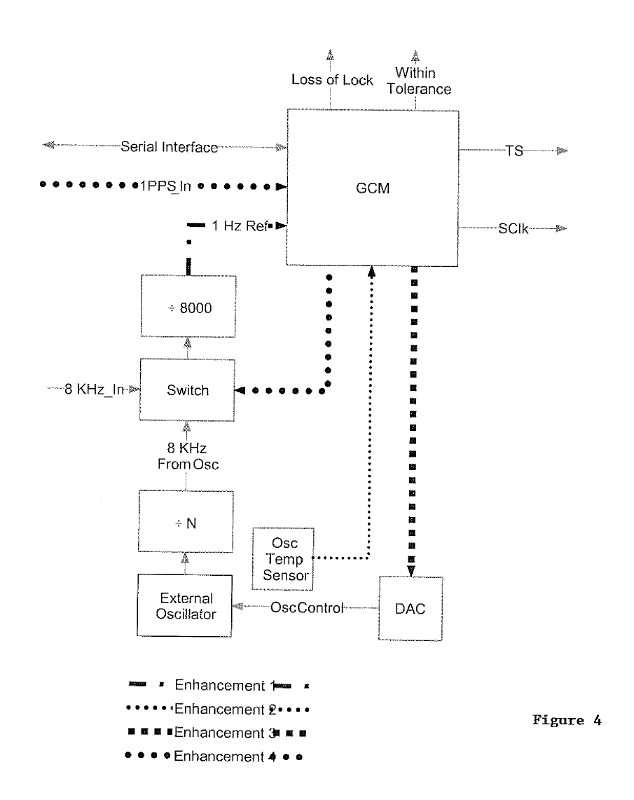

FIG. 4 illustrates an alternative approach using enhanced GCM Input-Output (I/O) functions to allow the integration of the synch discriminator function within the GCM itself. A few very simple but powerful I/O functions can be incorporated into the GCM to allow a number of alternative synchronization sources to be integrated into a synchronization hierarchy.

The core idea is to connect an external reference at, say, 1 Hz, to a GCM I/O with timing functionality (as illustrated by the 1 H_{z} Ref I/O in the figure). This I/O can be used by the firmware to estimate very precisely, the period of the external frequency reference. Then, during holdover, this precisely calibrated period can be used by the GCM to maintain time and frequency. This would allow an OCXO, as in the figure, to be used to substantially enhance the holdover performance of the GCM itself. Alternatively, it would allow a frequency reference derived from, say, SDH (typically 8 kHz) or NTP to be used as a backup during holdover.

Enhancement 2 involves modifying the GCM firmware to support interfacing an external temperature sensor to an Analog Measuring Unit (AMU) input (small dots in the figure). The firmware would then be enhanced to temperature compensate the external oscillator using the same algorithms as the firmware uses to temperature compensate the GCM's own internal Temperature Compensated Crystal Oscillator (TCXO).

This would allow the holdover performance of the GCM to be improved substantially using a lower cost OCXO or even a more expensive TCXO than that used within the GCM itself.

Enhancement 3 would add the ability to discipline the external oscillator while the GCM is locked to GPS. This would allow the external oscillator to be used as a system clock in its own right. This would allow the GCM to be used to satisfy requirements for system clock frequencies that it did not directly support as well as providing enhanced holdover performance based on the stability of the external oscillator.

In principle this could be done using a Pulse Width Modulator (PWM) output of the GCM together with a few passive external components. Alternatively, it could involve the use of an internal Digital-to-Analog-Convertor (DAC) or an external DAC which would interface to the GCM most conveniently using a SPI port (fat square dots in the figure).

Finally, Enhancement 4 involves support for a 1 PPS timing signal interfaced to a second timing input (large dots in the figure). This would be used by the firmware to control the absolute time of the 1 PPS output during holdover or, in fact, as a primary timing reference, depending on the application requirements. In addition, provision would be made to switch between an 8 kHz reference input and the external oscillator under firmware control (via the second large dots I/O in the figure) to meet application requirements.

With some subset of the four enhancements described, a very low cost

GCM can be adapted to meet more demanding holdover requirements by utilizing external syntonisation and synchronization sources. With all 4 enhancements, a highly integrated GCM such as that used in a femto-cell could be adapted to meet all the requirements of a full macro base station clock very cost-effectively compared to conventional approaches.

### Firmware Integration Schemes

### F/W Integration Scheme 1

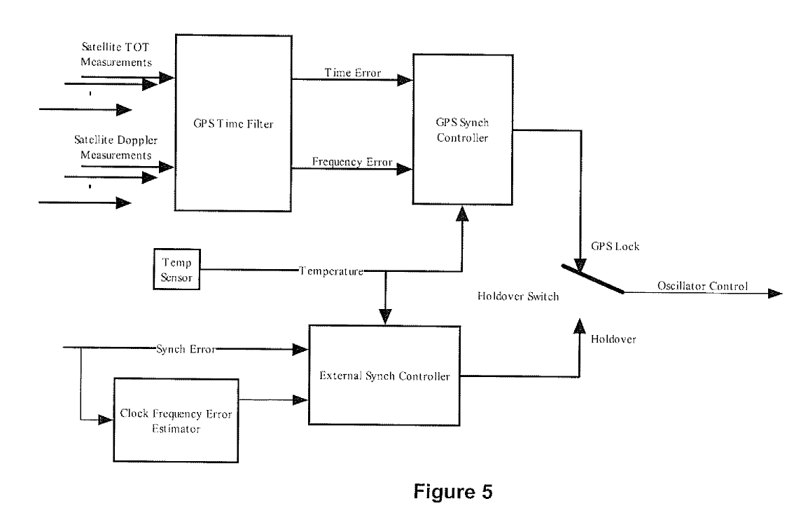

FIG. 5 illustrates one way in which the GPS baseband firmware could integrate the synch error measurements into its existing oscillator discipline regime. In this solution, separate synch controller algorithms are employed and the firmware switches between them based on whether GPS lock is maintained or the GCM is in holdover. The two different controllers take account of the statistical characteristics of their respective input error measurements. This is the simplest and most easily implemented approach to toggling the synchronization source.

As indicated in the diagram, master clock frequency errors are deduced from the input sequence of synch errors and both estimates (synch and frequency) are processed by the External Synch Controller. Note that this is feasible because the synchronization is strictly maintained through the oscillator discipline as discussed earlier. Because of that, the changes in synchronization error between any two points in time are proportional to the average clock frequency error between those two points in time.

In the preferred embodiment, either the External Synch Controller is or both synch controllers are supplied with oscillator crystal temperature measurements. These are used to improve oscillator discipline.

The use of temperature permits the oscillator drift to be compensated for by the controller especially during holdover when less precise frequency and synchronization error estimates are available. In the event that even these external measurements are not available, then the use of temperature measurements can extend the holdover period during which the GCM can maintain both the frequency and synchronization within specification.

The GPS time filter is a sequential Kalman filter that processes Time-Of-Transmission (TOT) measurements and Doppler frequency measurements from the available satellite signals to obtain estimates of absolute time error (with respect to GPS time) and master clock frequency error.

### F/W Integration Scheme 2

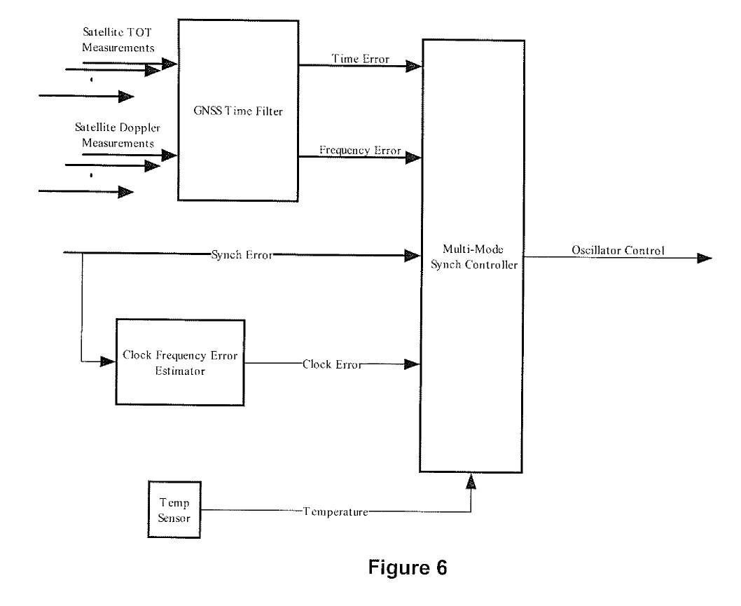

FIG. 6 depicts an alternative arrangement to that of FIG. 5 in which a single controller blends error information from both sources (GPS and External) when available. At any point, the controller takes account of which measurements are available and of their characteristics. This arrangement provides scope for better management of the transitions into and out of GPS holdover. One of the requirements that may have to be met during the transitions, for example, is to limit the rate of change of the oscillator frequency.

### F/W Integration Scheme 3

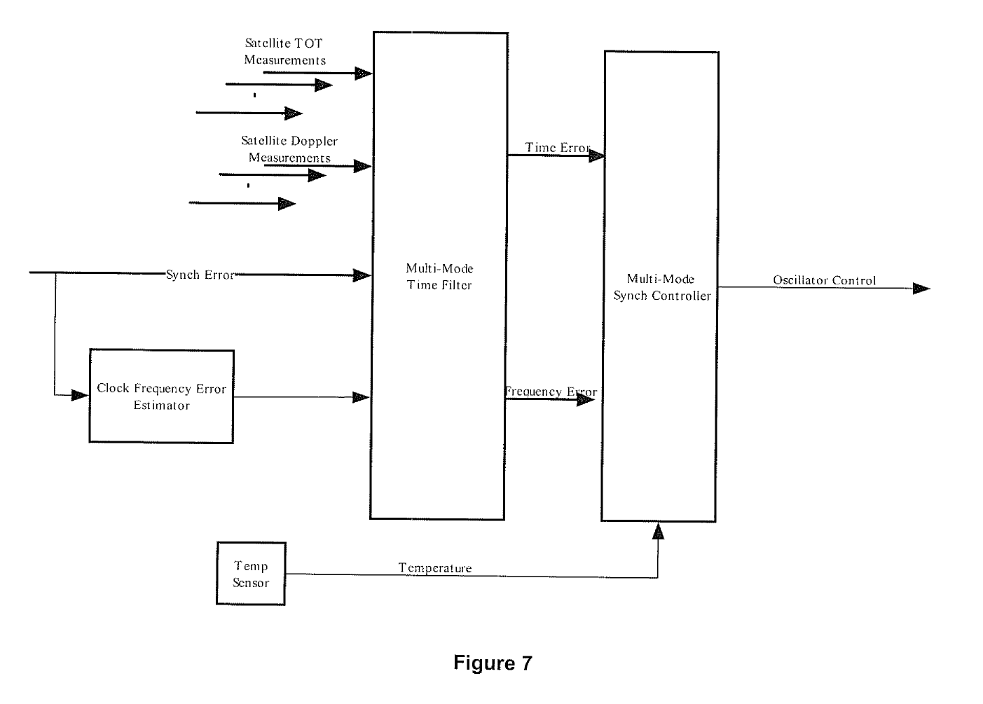

One characteristic of IP-based synchronization is that it suffers from time-varying biases. During GPS lock it is possible to estimate and track the time varying bias of the external synch error estimates. FIG. 7 represents a more sophisticated approach in which a more complex sequential Kalman filter processes the external synch and clock frequency estimates along with the satellite TOT and Doppler measurements. The state vector of this Kalman filter would include external synch error bias as well as time error and frequency error.

During GPS holdover, the filter would maintain the bias and it would be eliminated from the time error estimate passed to the controller. In this way, improved accuracy would be maintained during all but prolonged holdover periods.

Alternative forms of algorithms can also be envisaged, including a separate bias tracker, estimators other than a Kalman filter or more sophisticated Kalman filters that track the bias drift rate as well as the bias itself.

Although the invention has been discussed in terms of specific embodiments, persons of skill in this art will see its full utility. Accordingly the invention is intended to cover what is described in the following claims:

What we claim is:

1. A method comprising providing holdover backup in a GPS clock module used to provide syntonisation, synchronization, position or some combination to a wireless base station, micro-cell, pico-cell, femto-cell or access point, via at least one interface between the GPS clock module and external time or frequency references.

2. The method of claim 1 comprising informing the GPS clock module over a serial interface of errors in the GPS clock module time or frequency based on measurements made externally.

3. The method of claim 1 in which the GPS clock module estimates the precise time or precise period associated with edges of an externally generated timing or frequency reference while fixing and using the estimated times of the edges or the periods between them to maintain estimates of time and frequency during holdover.

4. The method of claim 3 further comprising deriving the said externally generated frequency reference by dividing a reference frequency from a reference oscillator.

5. The method of claim 4 further comprising interfacing a temperature sensor to the GPS clock module, characterizing the temperature characteristics of the oscillator by the GPS clock module and compensating for those characteristics during holdover.

6. The method of claim 4 comprising controlling or disciplining the said external reference oscillator using an output interface to the GPS clock module so as to set its frequency error closely to zero.

7. The method of claim 3 comprising deriving the said externally generated frequency reference from an SDH link.

8. The method of claim 3 comprising generating by an external GPS receiver the said externally generated timing reference.

9. The method of claim 3 comprising deriving the said externally generated timing reference from an SDH link.

10. The method of claim 3 further comprising switching between external timing or frequency references by use of one or more additional interfaces to the GPS clock module.

11. The method of claim 1 further comprising processing the externally derived frequency and/or time synchronization error estimates by using a separate synch controller firmware routine and switching oscillator control from the GPS synch controller to the external synch controller during holdover.

12. The method of claim 11 further comprising deriving said frequency error estimates from a sequence of time error estimates.

13. The method of claim 11 further comprising supplying the external synch controller with temperature estimates for use in frequency compensation of the internal oscillator.

14. The method of claim 1 further comprising using a single multi-mode synch controller firmware routine to process frequency and time error estimates from a GPS time filter and frequency and/or time synchronization error estimates obtained via external interfaces and controlling the internal oscillator based on a combination of error the said estimates.

15. The method of claim 14 further comprising deriving from a sequence of time error estimates said frequency error estimates obtained via external interfaces.

16. The method of claim 14 further comprising supplying the said multi-mode synch controller with temperature estimates for use in frequency compensation of the internal oscillator.

17. The method of claim 1 further comprises using a single multi-mode time filter to processes GPS measurements and frequency and/or time synchronization error estimates obtained via external interfaces to estimate time and frequency error based on a combination of all available measurements and error estimates.

18. The method of claim 17 further comprising using a single multi-mode synch controller to process the time and frequency error estimates produced by the multi-mode time filter and controlling the internal oscillator based on its input data.

19. The method of claim 17 further comprises deriving from a sequence of time error estimates said frequency error estimates obtained via external interfaces.

20. The method of claim 18 further comprises supplying to said multi-mode synch controller temperature estimates for use in frequency compensation of the internal oscillator.

21. A GPS clock module apparatus for providing syntonisation, synchronization, position or some combination to a wireless base station, micro-cell, pico-cell, femto-cell or access point, said module comprising an apparatus for providing holdover backup via at least one interface between the GPS clock module and external time or frequency references.

22. The apparatus of claim 21 in which one of the said at least one interfaces is a serial interface via which the GPS clock module is informed of errors in its time or frequency based on measurements made externally.

23. The apparatus of claim 21 in which one of the said at least one interfaces is an input via which the GPS clock module estimates the precise time or precise period associated with edges of an externally generated timing or frequency reference while fixing and then uses the estimated times of the edges or the periods between them to maintain its own estimates of time and frequency during holdover.

24. The apparatus of claim 23 in which the said externally generated frequency reference is derived by dividing a reference frequency from a reference oscillator.

25. The apparatus of claim 23 in which the said externally generated frequency reference is derived from an SDH link.

26. The apparatus of claim 23 in which the said externally generated timing reference is generated by an external GPS receiver.

27. The apparatus of claim 23 in which the said externally generated timing reference is derived from an SDH link.

28. The apparatus of claim 24 comprising a temperature sensor interfaced to the GPS clock module that enables the GPS clock module to characterize the temperature characteristics of the oscillator and to compensate for those characteristics during holdover.

29. The apparatus of claim 24 comprising another interface to the GPS clock module as an output used to control or discipline the said external reference oscillator so as to set its frequency error as closely as possible to zero.

30. The apparatus of claim 23 comprising one or more additional interfaces to the GPS clock module used to switch between external timing or frequency references.

31. The apparatus of claim 21 in which a separate synch controller firmware routine is used to process the externally derived frequency and/or time synchronization error estimates and oscillator control is switched from the GPS synch controller to the external synch controller during holdover.

32. The apparatus of claim 31 in which said frequency error estimates are derived from a sequence of time error estimates.

33. The apparatus of claim 31 in which the external synch controller is supplied with temperature estimates for use in frequency compensation of the internal oscillator.

34. The apparatus of claim 21 comprising a single multi-mode synch controller firmware routine processes frequency and time error estimates from a GPS time filter and frequency and/or time synchronization error estimates obtained via external interfaces and controls the internal oscillator based on a combination of all the error estimates available to it.

35. The apparatus of claim 34 in which said frequency error estimates obtained via external interfaces are derived from a sequence of time error estimates.

36. The apparatus of claim 34 in which the said multi-mode synch controller is supplied with temperature estimates for use in frequency compensation of the internal oscillator.

37. The apparatus of claim 21 in which a single multi-mode time filter processes GPS measurements and frequency and/or time synchronization error estimates obtained via external interfaces to estimate its time and frequency error based on a combination of all the measurements and error estimates available to it.

38. The apparatus of claim 37 in which a single multi-mode synch controller processes the time and frequency error estimates produced by the multi-mode time filter and controls the internal oscillator based on its input data.

39. The apparatus of claim 37 in which said frequency error estimates obtained via external interfaces are derived from a sequence of time error estimates.

40. The apparatus of claim 38 in which the said multi-mode synch controller is supplied with temperature estimates for use in frequency compensation of the internal oscillator.

41. The method of claim 17 further comprising estimating by the multi-mode time filter the bias in the externally derived time and frequency estimates and eliminating these biases during holdover.

42. The apparatus of claim 37 in which the multi-mode time filter estimates the bias in the externally derived time and frequency estimates and eliminates these biases during holdover.
